(19) United States
(12) Patent Application Publication
(10) Pub. No.: US 2016/0007414 A1
(43) Pub. Date: Jan. 7, 2016

(54) INDUCTION HOB

(71) Applicant: ELECTROLUX APPLIANCES AKTIEBOLAG, Stockholm (SE)

(72) Inventors: Laurent Jeanneteau, Forli (IT); Harald Hoffmann, Rothenburg ob der Tauber (DE); Jochen Holzinger, Rothenburg ob der Tauber (DE); Björn Leyh, Rothenburg ob der Tauber (DE); Andrea Zangoli, Forli (IT); Ulrich Häutle, Rothenburg ob der Tauber (DE); Gianluca Venturini, Forli (IT)

(21) Appl. No.: 14/770,975

(22) PCT Filed: Feb. 27, 2014
(86) PCT No.: PCT/EP2014/053786

§ 371 Date: Aug. 27, 2015

(30) Foreign Application Priority Data
Mar. 8, 2013 (EP) 13158293.4

(51) Int. Cl. H05B 6/12

(52) U.S. Cl. CPC H05B 6/1263

(57) ABSTRACT

An induction hob including in a stacked arrangement a coil carrier plate (2), an induction coil (3) and a cooktop plate (4). The induction coil (3) is supported on the coil carrier plate (2) by at least one elastic, in particular resilient, support element (5) which is made from an electrically insulating material. The support element (5) is implemented to generate an elastic force (F) urging the induction coil (3) towards the cooktop plate (4) at least in the ordinary working arrangement of the induction hob (1).

The present invention is directed to an induction hob.

Current induction hobs in general comprise a coil carrier plate on which an induction coil is positioned, which in turn is covered by a top cover, such as a glass ceramic plate.

The coil carrier plate in general may be made from a metal material in particular for the reasons of enhanced electromagnetic shielding, in particular EMI shielding. However, EMI shielding efficiency may be disrupted by mounting or positioning elements used for mounting or positioning the induction coil on the coil carrier plate. Hence, there is still need for mounting arrangements in induction hobs providing both good EMI shielding and robust and reliable attachment and positioning of induction coils.

Therefore it is an object of the invention to avoid the problems observed in state of the art induction cookers. In particular it is an object of the invention to provide an induction hob having good EMI-shielding and providing robust and reliable mounting possibilities for the induction coils.

This object in particular is solved by the independent claims. Further solutions and embodiments result from the dependent claims.

According to claim 1, an induction hob is provided which comprises in a stacked arrangement, i.e. in an arrangement in which respective elements are arranged on top of each other, a coil carrier plate, an induction coil and a cooktop plate.

The coil carrier plate in particular is adapted to support the induction coil in a load bearing manner. The coil carrier plate may be made from a material, in particular metal material such as aluminum, with good electromagnetic shielding properties.

The induction coil in particular may comprise a number of windings in a helical or spiral arrangement. The overall shape of the induction coil may be circular, oval, rectangular or of any other suitable geometry. The overall design of the induction coil, including but not restricted to the windings of the induction coil, preferably represents a flattened, disc or plate shaped geometry. In particular in this case, at least respective surface sections of the coil carrier plate and cooktop plate facing and being vertically aligned with the induction coil may also have respective flattened structures.

The cooktop plate, which in an ordinary vertical arrangement is arranged at the uppermost position, is adapted to support, on a side facing away from the induction coil, different types of cooking utensils. The cooktop plate is required to be made from a material permeable or even transparent for magnetic induction fields generated by the induction coil arranged beneath. As an example, the cooktop plate may be made from a glass ceramic.

With the proposed induction hob, it is provided that the induction coil is supported on the carrier plate by means of at least one elastic, in particular resilient, support element. Elastic or even resilient properties in particular shall mean that the respective support element is able to generate elastic or resilient forces upon applying loads or forces to the support element.

The support element is made from an electrically insulating material, wherein the support element and/or the insulating material, is implemented to generate an elastic force urging the induction coil towards the cooktop plate in the ordinary working arrangement of the induction hob.

Providing such an arrangement and comparatively fixed and spring-loaded mount of the induction coil between the coil carrier plate and cooktop plate has the advantage, that comparatively low EMI disturbances and good induction efficiencies can be obtained.

This in particular may be due to the fact that the induction coil and coil carrier plate, in particular in mutual overlapping regions, are supported against each other by the electrically insulating material. This positive effect in particular may be due to the fact of avoiding direct conductive contacts between the induction coil and coil carrier plate.

Besides the insulating effect, the induction coil in the ordinary final assembly may be urged towards, preferably onto, the carrier plate, in particular towards a lower side of the carrier plate. Bringing the upper side of the induction coil in a comparatively close contact with or to the lower side of the cooktop plate can help to reduce EMI noise.

Apart from obtaining advantageous EMI shielding properties, the proposed support element may be effective in reliably and robustly supporting the induction coil in shock absorptive manner on the coil carrier plate. This may help to reduce vibration and/or noise generated during operation of the induction hob.

An additional advantage of the proposed induction hob is that the induction coil is urged or pressed towards the cooktop plate, which may result in a gap, in particular air gap between the coil carrier plate and induction coil. The gap, in particular air gap may help to improve cooling of the induction coil, i.e. heat removal from the induction coil during operation can be enhanced.

It shall be mentioned that it is possible that an upper side of the induction coil is brought into direct contact with a lower side of the cooktop plate. This may lead to enhanced cooking performance and may help to reduce EMI interferences.

The at least one support element may, according to an embodiment, be made from a synthetic material, in particular from a plastic, rubber and/or silicone material. These materials in particular have been proven to provide sufficient electric insulation between the coil carrier plate and the induction coil, in particular the outer casing or envelope of the induction coil. In addition, the materials mentioned above may provide advantageous, in particular shock absorptive, properties, in turn leading to enhanced cooking and reduced noise and vibration during operation.

In a further embodiment, at least one support element is provided at and engaged with an extension projecting from a lateral face side of the induction coil. The extension may be in form of a fin, finlet or flat, sheet-like projection. The support element may be implemented to extend or project from the induction coil laterally in parallel to a coil plane.

In case of a circular or oval induction coil geometry, the extension may extend or project in radial direction from the induction coil. It shall be noted that additionally or instead of attaching or fixing the support element to the induction coil, it is also possible to attach the support element to the coil carrier plate. In this case, the coil may either loosely rest on a respective support element, or the coil, in particular a respective extension, may be engaged with the support element engaged with the coil carrier plate. In all, the support element can be attached either to the induction coil or to the coil carrier plate or to both the induction coil and coil carrier plate.

In a further embodiment at least one of the at least one support element is provided, in particular attached and/or engaged, within the footprint area of the induction coil at the lower side of the induction coil and/or at an upper side of the coil carrier plate. This in particular means that the support element can be arranged in any location within the footprint area of the induction coil between the induction coil and coil carrier plate. The number of support elements may and can be selected according to relevant dimensions and geometries of the induction coil, in particular in parallel to the coil carrier plate. The support element in particular may be attached, i.e. fastened by attachment means and/or via bonded connections. The support element may also or in the alternative be fixed via form-fit connections, in particular in which the support element or a section thereof engages a corresponding hole or extension provided at the induction coil. A respective hole or extension may for example be of circular or rectangular shape into which an engagement section of the support element can be engaged, in particular snapped into.

The support elements in particular may be arranged and positioned within the footprint area of the induction coil to support the induction coil without much deflection and bending relative to the coil carrier plate. In other words, the support elements can preferably be positioned within the footprint area of the induction coils such that deflection or bending of the induction coil is at least greatly avoided. This in particular leads to enhanced induction efficiency.

The support elements may in particular be arranged and mutually spaced in such a way that the vibrational modes of the induction coil are detuned for possible resonances occurring during operation of the induction coils. The avoidance of resonant vibrational modes may also be due to the fact that the support element is made from an elastic material. The elasticity of the material may in particular be adapted such that vibrational modes can greatly be avoided. It shall be noted, that the vibrational modes can be different for different types and sizes of induction coils. Therefore, the support elements may vary in at least one of material composition, shape and size for different types of induction coils.

In an embodiment, at least one spacer element is provided between the cooktop plate and the upper side of the induction coil, in particular within the footprint area of the induction coil. The spacer element may be made from same or similar materials like the support elements. In particular, the spacer element can be made from an electrically insulating material, in particular from a plastic, in particular silicone, material, having elastic, in particular spring elastic or resilient properties. The spacers may in particular be implemented such that the distance between the induction coil and the cooktop plate essentially is constant over essentially the whole footprint are ea of the induction coil. Adjusting the distance to be essentially constant may lead to enhanced induction efficiency and therefore cooking efficiency. However, it shall be noted that an air gap between the induction coil and the cooktop plate may be advantageous for a more efficient cooling of the induction coil.

The spacers above the induction coil may be placed and positioned, in particular relative to the at least one support element, in such a way, that deflection and bowing of the induction coil at least is greatly reduced or prevented. As an example, respective pairs of support elements and spacers may be arranged in mutual alignment on opposing sides of the induction coil. In most instances, the spacers are and will be selected such that the induction coil is oriented parallel to the cooktop plate.

According to a yet further embodiment, the support element and/or the spacer element is/are designed and sized such that in the ordinary mounted condition, a distance between the coil carrier plate and the induction coil and/or between the induction coil and the cooktop plate, is in the range from 1 mm to 5 mm. The distance in particular may be constant or essentially constant over the whole footprint area of the induction coil. Constant distances or gaps between respective elements can in particular contribute to enhanced cooking and improved EMI-properties.

In an embodiment, it may be provided that that at least one support element, and/or at least one spacer element is/are implemented as a singular spot or a beading, in particular a linear and/or curved beading. Such shapes in particular can be used for support and/or spacer elements arranged within the footprint area below or above the induction coil. A singular spot in particular may comprise a drop or ball shaped configuration. Beadings may comprise rectangular, circular and/or oval shaped configurations in planes parallel to the induction coil.

The diameter and/or length of the respective support and/or spacer in planes parallel to the induction coil and/or the cross section in planes perpendicular to the induction coil may be selected in dependence of induction coil parameters such as weight and/or size. In general, it may be that at least one of the number and shape of the support and/or spacer element or elements is selected in dependence of at least one induction coil parameter, such as induction coil weight and size. The shape may for example relate to the diameter, cross section, length and/or width in planes parallel or perpendicular to the induction coil.

The at least one support element and/or spacer element may, according to a further embodiment, be attached to the carrier plate, induction coil and/or cooktop plate by at least one of a mechanical, in particular a click or snap type, connection, by gluing, adhesion and bonding.

For snap type connections, the carrier plate and/or induction coil may comprise respective snap holes or recesses for respective spacer or support elements. Snap type connections in particular are suitable for reliably fixing and securing the induction coil between the carrier plate and cooktop plate in its ordinary mounting position. By using respective connections twists, movements or changes in the original mounting position of the induction coil, probably caused by inductive forces during operation of the induction coil, can be avoided. Note, that changes in the mounting position may impair induction based heating or cooking.

As can be seen, the proposed induction hob is suitable for ensuring effective induction based heating and cooking. In particular an induction hob can be provided that has good EMI-shielding properties and robust and reliable mounting possibilities for the induction coil.

According to claim 10, an oven, in particular domestic oven, in more general a domestic appliance is provided, which comprises an induction hob according to at least one embodiment and/or variant as described further above. As to advantages and advantageous effects of the oven or appliance, reference is made to the description above and further blow.

Embodiments of the invention will now be described in connection with the annexed figures, in which.

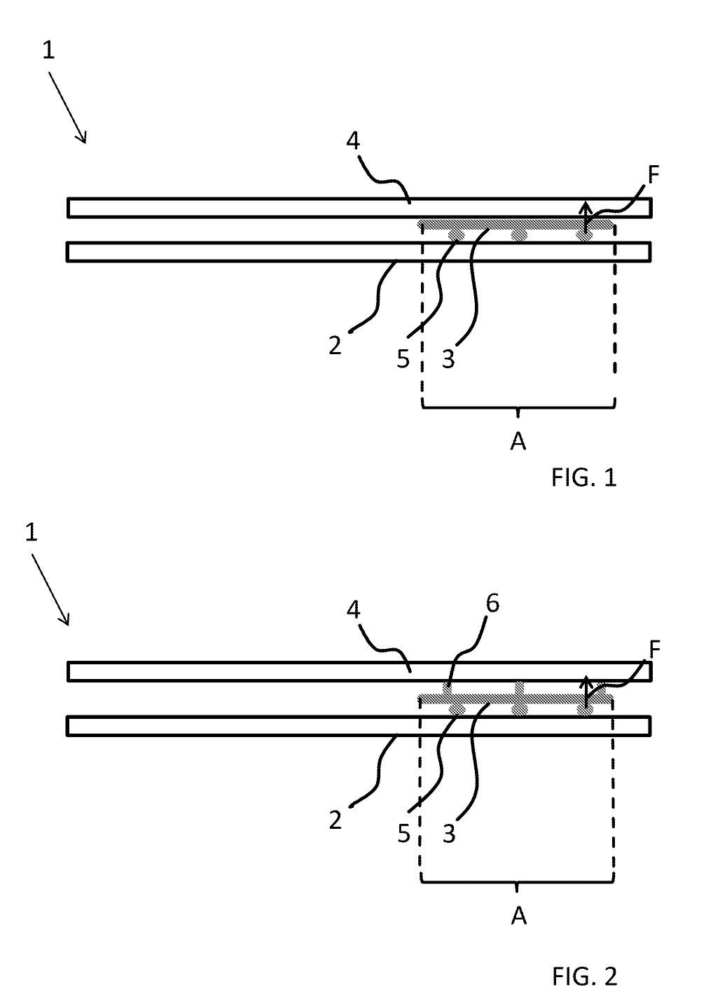

FIG. 1 shows a cross-sectional view of first variant of an induction hob;

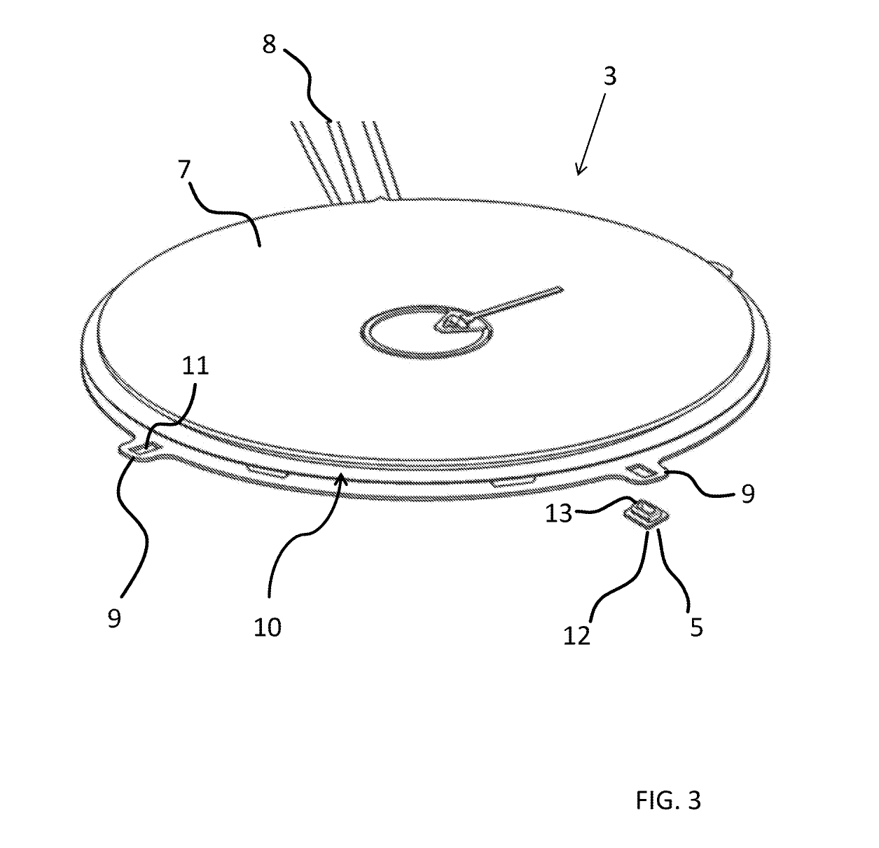

FIG. 2 shows a cross-sectional view of second variant of an induction hob;

FIG. 3 shows a perspective view of an induction coil;

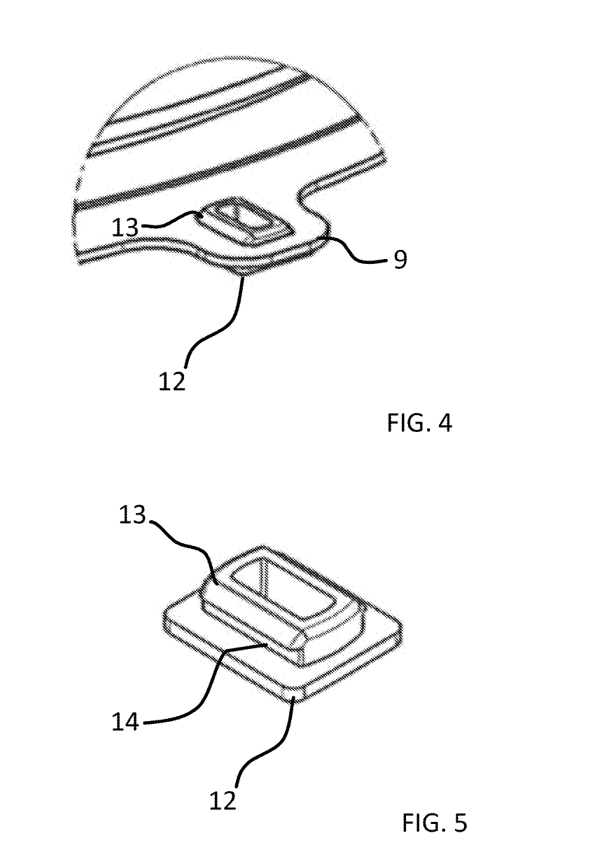

FIG. 4 shows a detail of the induction coil of FIG. 1;

FIG. 5 shows a support element of a first configuration;

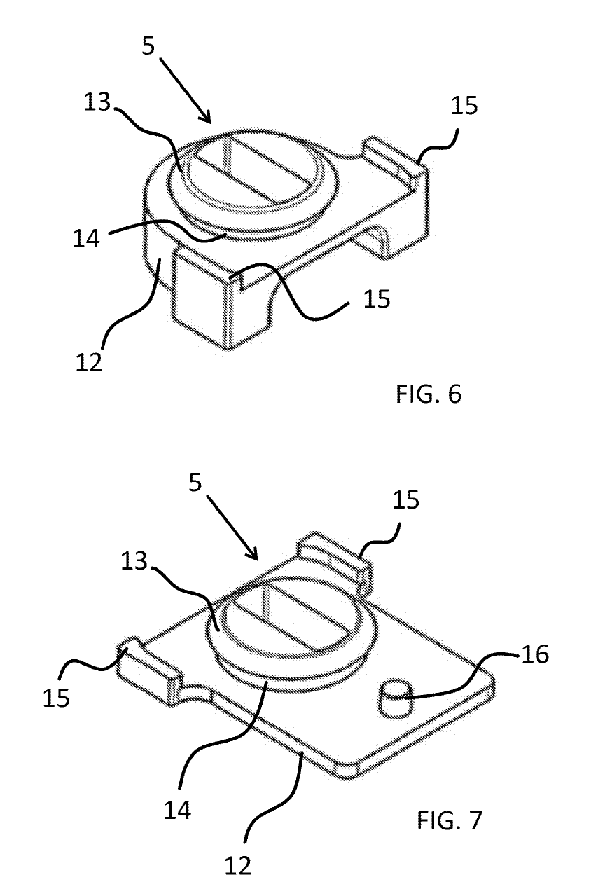

FIG. 6 shows a support element of a second configuration;

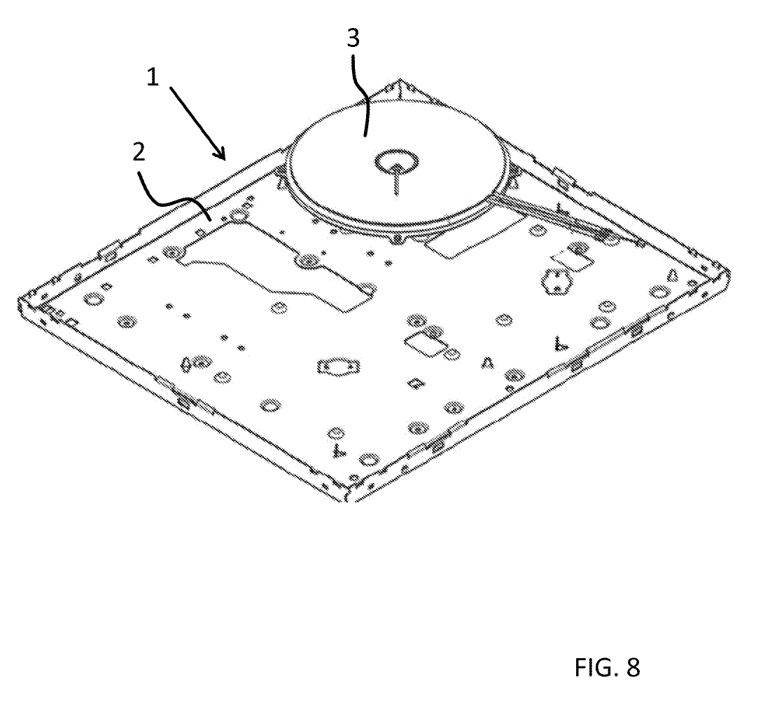

FIG. 7 shows a support element in a third configuration; and

FIG. 8 shows a perspective view of an induction hob in a partially assembled state.

Unless otherwise mentioned, like reference signs are used for like elements throughout the figures.

FIG. 1 shows a cross-sectional view of a first variant of an induction hob 1 comprising in a stacked arrangement, i.e. in an arrangement on top of one another, a coil carrier plate 2, an induction coil 3 and a cooktop plate 4.

The cooktop plate 4 is adapted and intended for placing thereon cookware and the like. The cookware plate 4 may in particular be made from a glass ceramic material. The induction coil 3 is placed below the cooktop plate 4 and is intended for inductively heating cookware qualified for induction heating. Inductive heating of cookware on respective cooktops is known in the art and will not be described to the most detail.

The induction coil 3 is supported on the coil carrier plate 2 by means of support elements 5. In the present case, there are visualized three support elements 5, distributed over the extension of the footprint area A of the induction coil 3. Note that the number of support elements may vary, in particular in dependence of the size of the footprint area A. In particular with comparatively small sized induction coils 3, a single support element 5, which may be provided in the center of the induction coil 3, may be sufficient. However, the number and position of the support elements 5 shall be selected such that the induction coil 3 is prevented from being bended, at least to an extent to avoid impairments in induction heating efficiency.

The support elements 5 are made from an elastic, in particular spring elastic, and electrically insulating material. A respective material in particular may comprise an elastic plastic material, in particular silicone.

The support elements 5 are implemented to generate, in the ordinary assembled configuration, an elastic force, indicated in FIG. 1 schematically by an arrow F, directed towards the cooktop plate 4. Hence, in particular in the embodiment in FIG. 1, the elastic force F urges the induction coil 3 towards the cooktop plate 4.

In the present embodiment, the induction coil 3 is directly pressed against the lower side of the cooktop plate 4. In this configuration and in particular due to the elastic force F, there is essentially no gap between the lower side of the cooktop plate 4 and the upper side of the induction coil 3. This may be advantageous for effective induction heating.

Further, due to the support elements 5 provided in a region below the induction coil 3 within the footprint area A, a gap, in particular air gap, is present or implemented between the coil carrier plate 4 and the induction coil 3. This gap in particular may permit air circulation and may contribute to advanced cooling of the induction coil 3. Further, as the support elements 5 are made from an electrically insulating material EMI can greatly be avoided. In all, the support elements 5 are suitable in providing robust and reliable mounting and EMI shielding.

FIG. 2 shows a cross-sectional view of a second variant of an induction hob 1. The difference between the induction hob 1 of FIG. 1 and the induction hob 1 of FIG. 2 is that the induction coil 3 of the embodiment of FIG. 2 is spaced from the cooktop plate 4, such that an air gap is formed there between.

The spacing between the cooktop plate 4 and the induction coil 3 is obtained in that spacer elements 6 are provided between the upper side of the induction coil 3 and the lower side of the cooktop plate 4. The spacer elements 6 may also be made from an elastic, in particular spring elastic, electrically insulating material, such as for example plastic, in particular in the basis of silicone.

Via the spacer elements 6, an air gap between the lower side of the cooktop plate 4 and the upper side of the induction coil 3 is obtained. This additional air gap may be useful for improving cooling of the induction coil 3. In addition, the additional air gap may be adjusted in its dimensions to obtain optimal EMI characteristics and induction heating efficiency.

The support elements 5 and spacer elements 6 may either be attached to the induction coil 3 or attached to the coil carrier plate 2 or cooktop plate 4. The attachment of the support element 5 and spacer element 6 in particular may comprise snap connections, in particular comprising snap connectors and corresponding snap cutouts, adhesive and/or bonding connections.

The spacer elements 6 in particular are arranged and distributed over the upper side of the induction coil, in particular relative to the support elements 5, such that bending of the induction coil 3 can greatly be avoided.

It shall be noted, that the support elements 5 and spacer elements 6 may be designed such that a gap remaining between the coil carrier plate 2 and induction coil 3 or between the induction coil 3 and the cooktop plate 3 has a height in between 1 mm and 5 mm. Such gaps have been proven advantageous in particular for performances and designs as used for domestic induction cookers.

Reference is now made to FIG. 3 which shows a perspective view of an induction coil 3, in particular an induction coil 3 that may be used for the embodiments in FIG. 1 and FIG. 2.

The induction coil 3 according to FIG. 3 comprises a flat and disc like coil assembly, comprising at least one induction coil, integrated in an outer casing 7, cladding or envelope. Supply lines 8 are provided for connecting the induction coils within the outer casing 7 to an energy source (not shown). So far, the design of the induction coil 3 of FIG. 3 may correspond to that of FIG. 1 and FIG. 2.

In difference to the schematic induction coils 3 of FIG. 1 and FIG. 2, the induction coil 3 in FIG. 3 shows some more constructional details. However, it shall be mentioned that the induction coils 3 according to FIG. 1 and FIG. 2 may have the same design and construction as the induction coil 3 in FIG. 3.

The induction coil 3 in FIG. 3, in more detail the outer envelope or outer casing 7 thereof, has a disc-shaped geometry and comprises extensions 9 or projections extending or projecting radially, at a lateral face side 10 of the outer casing 7 from the outer casing 7.

The extensions 9 respectively comprise a recess 11 adapted to respectively receive a corresponding support element 5. The support elements 5 in the present embodiment are in the form of pad like support bases, i.e. support pads. The support pads 5 comprise a rectangular base section 12 and a latching section 13 projecting from the base section 12. Details of an extension 9 with a support pad 5 attached thereto can be seen in FIG. 4.

The latching section 13, having a rectangular axial cross section, is adapted to pass through a corresponding rectangular recess 11 and engage behind the recess opening such that the recess inner rim is placed in a groove 14 of the support pad 5. FIG. 5 shows a detailed perspective view of the support pad 5.

The support pad 5 according to FIG. 3 to FIG. 5 in particular is made from an elastic, electrically insulating material, such that the induction coil 3 can be urged towards the cooktop plate 4 in the assembled state.

Apart from urging the induction coil 3 upwards, the support pad 5 provides a damping effect and thus can reduce vibrations of the induction coil 3. In the embodiment of FIG. 3 to FIG. 5, the support pad 5 or support element is fastened to the induction coil 3. It shall however be noted, that the support elements 5 can also be fastened to the coil carrier plate 2, or even both to the coil carrier plate 2 and induction coil 3.

FIG. 6 and FIG. 7 respectively show perspective views of support elements of a second and third configuration, respectively.

In FIG. 6, the latching section 13 has a circular or cylindrical shape, and the base section 12 has a semi-circular shaped cross section. At respective ends of the circular contour, there are provided positioning cheeks 15 projecting upwards from the base section 12. The positioning cheeks 15 are adapted to laterally abut against sections of the outer edge of a respective induction coil extension 9. The positioning cheeks 15 are advantageous for avoiding twists of the support element 5 within the recess 11, in particular as the latching section 13 of the present embodiment has a circular axial cross section. In particular, it can be ensured that the induction coil 3 is optimally supported on the support element 5.

Further, it is noted that the support element 5 of the present configuration has a concave or hollow bottom shape, such that only an outer rim will be in contact with the coil carrier plate 2. This may be advantageous for elastic force generation and vibration damping.

The support element 5 according to the third configuration as shown in FIG. 7 differs from that of FIG. 6 in that the base section 12 has a rectangular shape, which is similar to the support element in FIG. 5. The latching section 13 of the support element 5 has a circular axial cross section, similar to the one shown in FIG. 6.

The support element 5 of FIG. 7 also comprises positioning cheeks 15. The positioning cheeks 15 are arranged at a longitudinal end of the base section 12 and protrude upwards at lateral sides of the base section 12. The support element 5 of FIG. 7 further comprises at the other longitudinal end a positioning pin 16, adapted to engage a positioning hole or opening (not shown) of a corresponding induction coil extension 9. The positioning pin 16 helps to avoid twisting of the support element 5.

It shall be noted, that all the elements as described in connection with the support elements of FIG. 5 to FIG. 7, in particular the positioning cheek 15 and positioning pin 16 and the shape and form of the base sections 12 and latching sections 13, can be used in arbitrary combinations.

Reference is now made to FIG. 8 showing a perspective view of an induction hob 1 in a partially assembled state. As can be seen, the induction coil 3 rests on the coil carrier plate 2 via the support elements 5 which are engaged in the recesses 11 of the extensions 9.

It shall be noted, that between the lower side of the induction coil 3 and the upper side of the coil carrier plate 2, in particular in the center region of the induction coil 3, there may be additional support elements 5. Such support elements are advantageous for avoiding bending of the induction coil 3 and may lead to a better heating efficiency.

The coil carrier plate 2 can be equipped with further induction coils 3, in particular with four induction coils 3 in total. A cooktop plate 4, in particular a ceramic cooktop plate, may be positioned over the induction coils 3. The assembly then can be considered as an induction cooktop, which can readily be used for domestic ovens.

In FIG. 5 to FIG. 7, the support elements 5 were shown as support pads. However, it shall be mentioned that the support elements may also be in the form of spots or beadings, in particular linear and/or curved beadings, made from an elastic and electrically insulating material. Other shapes and variants of support elements are conceivable.

In all, and in particular with reference to the figures, it can be seen, that good EMI-shielding can be obtained and advantageous, in particular robust and reliable mounting possibilities for the induction coil can be obtained.

### LIST OF REFERENCE NUMERALS

1 induction hob
2 coil carrier plate
3 induction coil
4 cooktop plate
5 support element
6 spacer element
7 outer casing
8 supply line
9 extension
10 lateral face side
11 recess
12 base section
13 latching section
14 groove
15 positioning cheek
16 positioning pin
A footprint area
F elastic force

What is claimed is:

1. Induction hob (1) comprising in a stacked arrangement a coil carrier plate (2), an induction coil (3) and a cooktop plate (4), wherein the induction coil (3) is supported on the coil carrier plate (2) by at least one elastic support element (5) which is made from an electrically insulating material and which is implemented to generate an elastic force (F) urging the induction coil (3) towards the cooktop plate (4) at least in the ordinary working arrangement of the induction hob (1).

2. Induction hob (1) according to claim 1, wherein the at least one support element (5) is made from a synthetic material.

3. Induction hob (1) according to claim 1, wherein at least one support element (5) is provided at an extension (9) of the induction coil (3), wherein the extension (9) projects laterally from a lateral face side (10) of the induction coil (3).

4. Induction hob (1) according to claim 1, wherein at least one of the at least one support element (5) is provided within the footprint area (A) of the induction coil (3) at the lower side of the induction coil (3) and/or at an upper side of the coil carrier plate (2).

5. Induction hob (1) according to claim 1, wherein at least one spacer element (6) is provided between the upper side of the induction coil (3) and the cooktop plate (4).

6. Induction hob (1) according to claim 1, wherein the support element is designed and sized such that in the ordinary mounted condition, a distance between the coil carrier plate and the induction coil and/or between the induction coil and the cooktop plate, is in the range from 1 mm to 5 mm.

7. Induction hob (1) according to claim 1, wherein at least one support element (5) is implemented as a singular spot or a beading, in particular a linear and/or curved beading.

8. Induction hob (1) according to claim 1, wherein at least one of the number and the shape of the support elements (5) is selected in dependence of at least one of the induction coil weight and size.

9. Induction hob (1) according to claim 1, wherein the at least one support element (5) is attached to at least one of the coil carrier plate (2), the induction coil (3) and the cooktop plate (4) by at least one of a click or snap type connection, gluing, adhesion and bonding.

10. Oven, in particular domestic oven, comprising a cooktop having at least one induction hob (1) according to claim 1.

11. Oven according to claim 10, wherein the cooktop comprises a cooktop plate (4) made from a glass ceramic material.

12. Oven according to claim 2, wherein the support element is made of plastic or silicone.
